(19) United States
(12) Patent Application Publication
(10) Pub. No.: US 2010/0064545 A1
(43) Pub. Date: Mar. 18, 2010

(54) AIR DRYER AND SANITIZER

(76) Inventors: Shirley Pollack, Clearwater, FL (US); Bruce Harris, Clearwater, FL (US); Thomas Saliga, Tampa, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/560,484

(22) Filed: Sep. 16, 2009

Related U.S. Application Data
(60) Provisional application No. 61/098,116, filed on Sep. 18, 2008.
(60) Provisional application No. 61/098,468, filed on Sep. 19, 2008.

(51) Int. Cl. F26B 3/32

(52) U.S. Cl. 34/275

(57) ABSTRACT

A method of treating an infant's bottom while changing diapers and a method employing such device involves a handheld blower and bactericide generator. The blower forces warmed air against the infant's bottom and ultraviolet lights supported in the blower irradiate the infant's body and the heated air to reduce bacteria. The ultraviolet lights are pulsed to enhance the antibacterial action.

### CROSS-REFERENCE TO RELATED APPLICATIONS

This application claims priority of U.S. Provisional Patent Applications Ser. No. 61/098,116 filed Sep. 18, 2008, and Ser. No. 61/098,468 filed Sep. 19, 2008, which are incorporated herein by reference.

### FIELD OF THE INVENTION

The present invention relates generally to a blower and heater for air and to a method of treating an infant's bottom during the diaper changing process which involves blowing heated air onto the bottom and irradiating it with ultraviolet light that reduces bacteria.

### BACKGROUND OF THE INVENTION

U.S. Pat. No. 6,928,235 discloses a forced air dryer for infants' bottoms which is used to dry the infant's bottom during the diaper changing process. That device may also be used to dry other body parts.

The air drying is intended to reduce skin irritation, commonly known as diaper rash, on the infant's body, attributable in part to the moist environment. The device disclosed in that previous patent is hand held, powered by a rechargeable battery, and supported, when not in use, on a charging stand.

While drying a baby's bottom with heated pressurized air reduces the incidence of diaper rash, the temperature of heated air is not sufficient to destroy bacteria which may be present from incomplete cleaning of the area before application of heat. This bacteria can cause dermatitis, much like diaper rash, unless it is further treated.

### SUMMARY OF THE INVENTION

Accordingly, the present invention not only dries the skin of a baby during the diaper changing process but additionally, and simultaneously, irradiates the bottom area with ultraviolet light, and preferably pulsed UV light, to kill bacteria which may be present on the baby's bottom.

In a preferred embodiment of the invention, which will be subsequently disclosed in detail, this bacterial irradiation is generated by blue light emitting diodes (LEDs). The LEDs, which emit light in the UV range, are arrayed about the perimeter of the blower and direct their radiation in the same direction as the heated air.

The UV LEDs employed with the preferred embodiment of the invention typically have an emission spectrum including some overlap into the visible range so as to provide visible illumination of the baby's bottom during the treatment process. The LEDs are preferably amplitude modulated or pulse modulated to enhance the antibacterial effect.

### BRIEF DESCRIPTION OF THE DRAWINGS

Other objects, advantages and applications of the present invention will be made apparent by the following detailed description of a preferred embodiment of the invention. The description makes reference to the accompanying drawings in which:

FIG. 1 is a perspective view of a handheld forced air dryer embodying UV LEDs to irradiate the area being dried, forming a preferred embodiment of the invention;

FIG. 2 is a cross-sectional side view of the preferred embodiment of FIG. 1;

FIG. 3 is a cross-sectional side view of a modified form of my invention in which the UV LEDs are disposed on the exterior of the blower nozzle; and

FIG. 4 is a schematic diagram of the electrical circuitry of the invention.

### DETAILED DESCRIPTION OF A PREFERRED EMBODIMENT

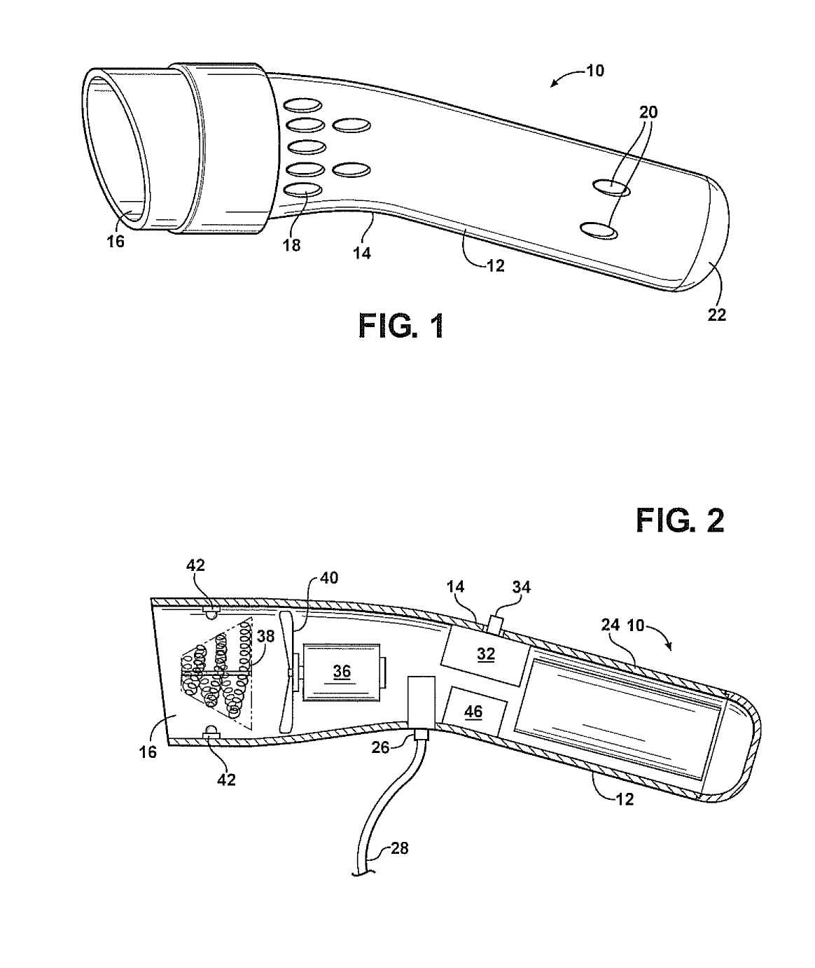

Referring to FIG. 1, a preferred embodiment of the present invention, generally indicated at 10, comprises a cylindrical shaped housing 12 of suitable dimensions to be easily hand held. The cylinder has a bend 14 formed approximately one-third of the length of the housing 12 from the output end 16. The bend is slight, preferably in the range of 5-20 degrees, to allow the output end 16 to be more easily manipulated. The end 16 is preferably truncated at a slight degree to the central axis of the housing 12 largely for aesthetic purposes.

A resilient end piece, covering the output 16, like the foam member 24 may be employed to protect an infant from being touched by the hard end, which may be hot.

The housing 12 has a number of holes 18 formed close to the bend 14 which allow air intake to the interior of the housing 12. A pair of air intake holes 20 may also be formed closer to the handle end 22 of the housing 12.

FIG. 2 is a cross section through the unit 10 illustrating the major components within the housing. The unit is powered by a rechargeable battery 24 supported at one end of the housing 12. To recharge the battery, a plug 26 is inserted into a connector formed in one side of the housing. A cord 28 connects the plug 26 to a source of approximately 3.5 volts DC, which may constitute an electronic circuit including a rectifier that plugs into a conventional alternating current wall socket. The plug 26 provides recharging voltage to a unit 30 disposed within the housing, which connects to the battery and regulates the applied voltage so that overcharging does not occur. A finger-actuated switch 32 located within the housing has its control button 34 projecting out of the housing. It preferably constitutes a three-position switch. In one position the unit is off and no power is applied to the circuitry, in the second position power is supplied both to a fan motor 36 and a heating element 38, and in the third position power is only applied to the fan motor 36 so as to blow unheated air out of the unit 10. The fan motor 36 powers a fan blade 40 which draws air in from the holes 18 and 20 and forces it out of the end 16 of the housing. This air passes over the heating element 38 which may heat the air. A plurality of light emitting diodes 42 are disposed about the interior of the housing surrounding the heater element 38. These units are also powered by the battery when the switch 34 is in either of its on positions.

The LEDs 42 may constitute “ultraviolet” LEDs which have an emission spectrum in the range of 300-390 nm or “blue” lasers having an emission spectrum centered about slightly higher wavelengths. The LEDs, in addition to emitting ultraviolet light, preferably emit visible wavelengths to provide illumination of the area being dried by the user of the device 10. The visible spectrum extends above about 385 nm, and the LED is preferably chosen to have a portion of its emission in that band.

The electronics for the unit 10 are preferably contained within the housing in a unit 46. The unit includes the control electronics for the fan, the heater, and the LEDs and is schematically illustrated in FIG. 4.

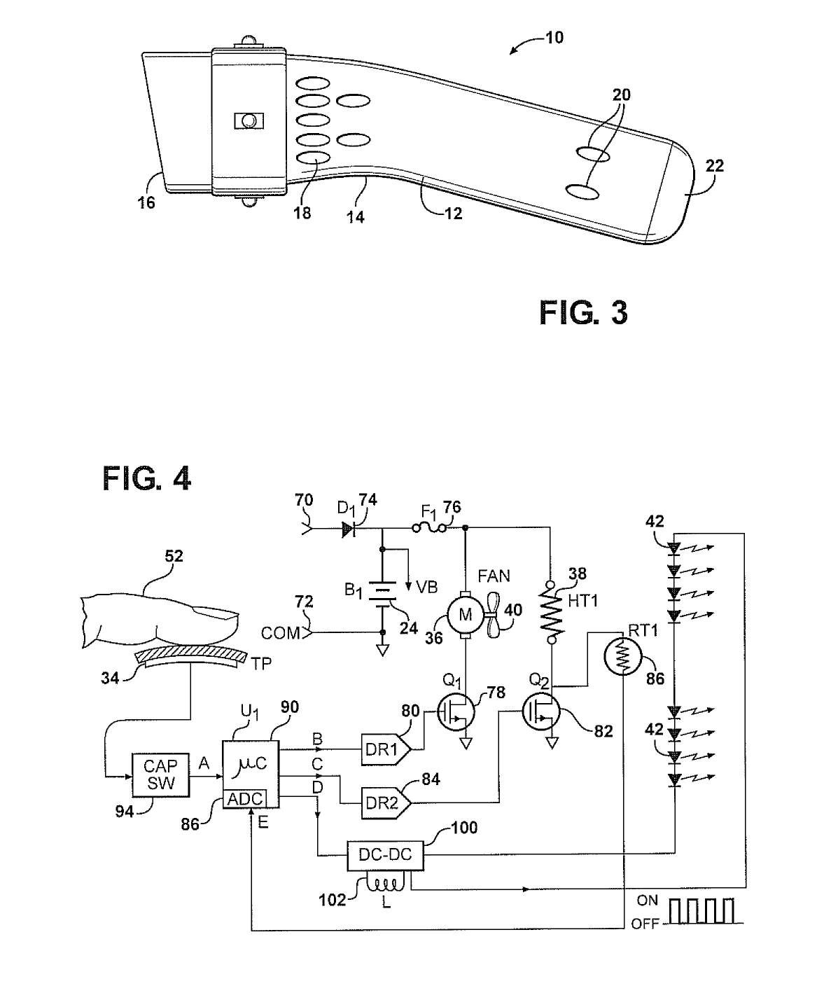

FIG. 3 illustrates an alternative construction for the dryer and sanitizer, generally indicated at 50. It primarily differs from the unit 10 in that the LEDs 42 are disposed about the exterior of the housing 52, adjacent the output end 16 so as to illuminate and provide antibacterial radiation to the air emanating from the housing.

FIG. 4 schematically illustrates the control electronics, which are preferably retained in a module 46 in the housing 14 of the embodiment generally indicated at 10. The battery 24 is preferably a lithium ion, nanophosphate cell which outputs about 3 volts under load. The terminals 70 and 72 are powered through the removable connector 26 to provide charging current to the battery through a protective diode 74. A fuse 76 protects the battery against overheating in the event of a failure mode short circuit developing on the load side of the battery including the motor and heater. The DC motor 36 and the attached fan blade 40 drive air across a resistance heater 38 when transistor 78, which is connected in series with the motor 36 to ground, is enabled by a signal from driver circuit 80. Similarly, the heater 38 may be selectively enabled by a transistor 82 controlled by a driver circuit 84. The drivers 78 and 82 may include a voltage step-up function to assure that the transistors 78 and 82 have sufficient drive voltage when turned on.

A thermal temperature sensor 86, preferably constituting a thermistor, senses the exit air stream temperature. Its analog output is provided to an analog-digital converter 86 resident in microprocessor 90, which also provides input signals to the driver circuits 80 and 84. The microprocessor 90 is programmed to disable the heater driver 84 should the air temperature exceed a preset threshold. In normal operation, the heater, power and air flow are designed to provide an exit temperature below about 120° F., and the preset cutoff temperature threshold is set about 10° higher. Thus the sensor 38 primarily serves a safety role in normal operation.

In the preferred embodiment the operator's on-off switch 34 is a capacitance operated switch circuit 94 with a connected finger touch plate which may be placed on the underside of the plastic housing. Alternatively a conventional two or three position slideswitch could be used to control the use of the blower alone, the blower and heater, and “off.” The programming of microprocessor 90 is such that a single quick touch and release by a finger will turn on both the fan and heater, and another touch may turn both off again. Further, by holding down the button 34 for a more elongated period, full manual control of the device may be achieved. The LEDs 42 are preferably connected in series and driven by a step-up power supply DC-DC converter 100 which contains a low loss inductor 102. This circuit may be pulsed on and off in a rapid fashion via a control line from the microprocessor 90. Typically, the resultant wave form may be a 50% duty cycle square wave.

The pulse rate is preferably chosen so that the emission acts as a bactericide. A typical frequency might be 727 Hz, which is known to be harmful to bacteria.

Having thus disclosed our invention, we claim:

1. A dryer and sanitizer, comprising:
a housing having an air inlet and an air outlet;
an air heater mounted within the housing;
an electric fan mounted within the housing operative to force air through the outlet;
a source of ultraviolet radiation supported on the housing so as to project light in the same direction as the air forced out of the outlet; and
a rechargeable battery supported in the housing and operative to power the electric fan, the air heater and the ultraviolet radiation source.

2. The dryer and sanitizer of claim 1 wherein the ultraviolet radiation comprises a plurality of UV LEDs arranged in spaced relationship to one another about the air outlet.

3. The dryer and sanitizer of claim 2 wherein the UV LEDs have emission spectra which includes visible light to provide illumination of the area subjected to forced air.

4. The dryer and sanitizer of claim 2 further comprising a microprocessor powered by said battery and operative to connect the battery to the LEDs so as to energize them with pulses.

5. The dryer and sanitizer of claim 4 in which the pulse rate is at a level scientifically established to be harmful to bacteria.

6. The method of drying and sanitizing an infant's bottom as part of a diaper changing process, comprising treating the infant's bottom with a device that blows heated air and projects ultraviolet light in the same direction as the air over the baby's bottom, to dry the bottom and sanitize it.

7. The method of claim 6 wherein the ultraviolet light is generated by LEDs.

8. The method of claim 7 wherein the LEDs are powered by a rechargeable battery.

9. The method of claim 7 in which the LEDs have emission spectra which includes visible light.

10. The method of claim 7 wherein the LEDs are periodically pulsed.

11. The method of claim 10 wherein the duty cycle of the LEDs is approximately 50%.

12. The method of claim 10 wherein the pulse rate of the LEDs is approximately 700 Hz.
